(19) United States
(12) Patent Application Publication
(10) Pub. No.: US 2003/0154728 A1
(43) Pub. Date: Aug. 21, 2003

(54) Device for thermal stabilisation of an object to be cooled

(76) Inventors: Jean-Paul Perin, Seyssins (FR); Olivier Chanal, Tanneron (FR)

Correspondence Address: PEARNE & GORDON LLP, 526 SUPERIOR AVENUE EAST, SUITE 1200, CLEVELAND, OH, 44114-1484, US

(21) Appl. No.: 10/297,193

(22) PCT Filed: Jun. 27, 2001
(86) PCT No.: PCT/FR01/02035

(30) Foreign Application Priority Data
Jun. 28, 2000 (FR) 00 08301

(51) Int. Cl. F25B 19/00; B01D 8/00

(52) U.S. Cl. 62/55.5; 62/51.1

(57) ABSTRACT

The invention relates to a device for thermally stabilizing an object (20) to be cooled to a temperature of the order of 6 to 25 K by circulating a fluid, characterized in that it comprises:

a Dewar flask (10) pressurized so as to provide a gas;

a coaxial exchanger (11) for pre-cooling the gas;

a cryostat (16) in which the object to be cooled is placed;

a coaxial siphon (13) for transferring the gas from the Dewar vacuum flask to the cryostat, this siphon including at least one sieve (14) providing thermal filtration of the gas, and

a variable flow outlet port (17) providing discharge of the gas.

### FIELD OF THE INVENTION

The invention relates to a device for thermally stabilizing an object to be cooled, in particular in the range of temperatures from 5 to 50 K, by circulating a fluid.

The invention finds applications in a number of fields wherein it is important to cool an object of small dimensions (a few cubic centimeters) and to maintain the object at a stable temperature. In particular, the invention finds applications in the field of infrared detectors, the precision of which may depend on temperature stability, or even in the field of x-radiations in order to maintain at low temperature samples to be analyzed with x-rays.

### State of the Art

Currently, in order to cool an object to a temperature of from 5 to 30 K by circulating a fluid, gas flows obtained by sampling some liquid into a pressurized flask by means of a siphon, are used. At the siphon outlet, the obtained fluid is in a biphasic form; it is then injected into a phase separation box so as to only retain the gas.

An example of a phase separation box as classically used is represented in FIG. 1; it bears reference number 1.

The siphon bringing the biphasic fluid (F) into the chamber 1 is referenced as 2. This biphasic fluid is generally helium; the latter separates into liquid helium contained in area Z1 on the one hand and on the other hand, into helium gas contained in area Z2 in the phase separation box 1.

Helium in the gaseous form (G) is sampled from above the liquid bath of area Z1 and discharged through an outlet port 3 out of the phase separation box.

A heating device 4 is installed on the phase separation box 1 providing heating of the box 1 and, consequently maintaining the liquid level constant. With a thermometer 5, the temperature of the gas at the outlet 3 of the box 1 may be checked.

Such systems are described, notably in the article entitled “Phase separator for liquid nitrogen supply lines” by B. V. ELKONIN, Cryogenics 1995, Vol. 35, No. 5, pp. 347-348.

However, these systems exhibit temperature fluctuations in the sampled gas that may be relatively large; i.e. of the order of a few hundred millikelvins.

### DISCUSSION OF THE INVENTION

The object of the invention is precisely to find a remedy to the drawbacks of the aforedescribed device.

For this purpose, it provides a cooling device by circulating a fluid with which a temperature of from 5 to 50 K may be obtained with stable fluctuations of the order of several millikelvins.

More specifically, the invention relates to a device for thermally stabilizing an object to be cooled at a temperature of the order of 5 to 50 K by circulating a fluid, characterized in that it comprises:

a pressure regulated Dewar flask for providing a gas;

a means for pre-cooling the gas;

a cryostat in which the object to be cooled is placed;

a coaxial siphon for transferring the gas from the Dewar flask to the cryostat, said siphon comprising at least one sieve providing thermal filtration of the gas; and

a variable flow outlet port providing discharge of the gas.

Advantageously, the sieve is comprised of lead or rare earth beads. Preferably, the beads have a diameter of the order of 200 to 500 μm.

According to one embodiment of the invention, the device includes two sieves arranged in the siphon; one is positioned at the outlet of the exchanger and the other is upstream from the object to be cooled.

The siphon of the device according to the invention advantageously includes a thin wall made of stainless steel.

In the preferred embodiment of the invention, the gas is helium.

### BRIEF DESCRIPTION OF THE DRAWINGS

FIG. 1, already described, represents a classical device for cooling by circulation of a fluid;

FIG. 2 schematically represents the device according to the invention;

FIGS. 3A and 3B represent two curves showing the change in temperature of an object when the device according to the invention comprises no sieve or a sieve at the siphon outlet, respectively,;

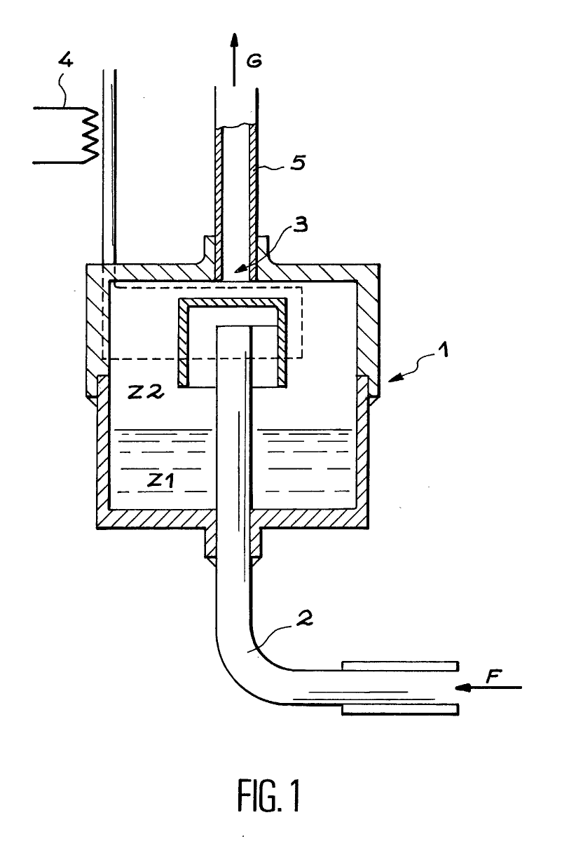

and FIGS. 4 and 5 illustrate two improvements that may be adapted either separately or together.

### DETAILED DESCRIPTION OF THE EMBODIMENTS ACCORDING TO THE INVENTION

The invention relates to a device for thermally stabilizing an object cooled to a temperature of the order of 5 to 30 Kelvins.

With this circulating fluid type device, an object of small dimensions may be cooled to a temperature of the order of from 5 to 30 Kelvins with a very low fluctuation in temperature.

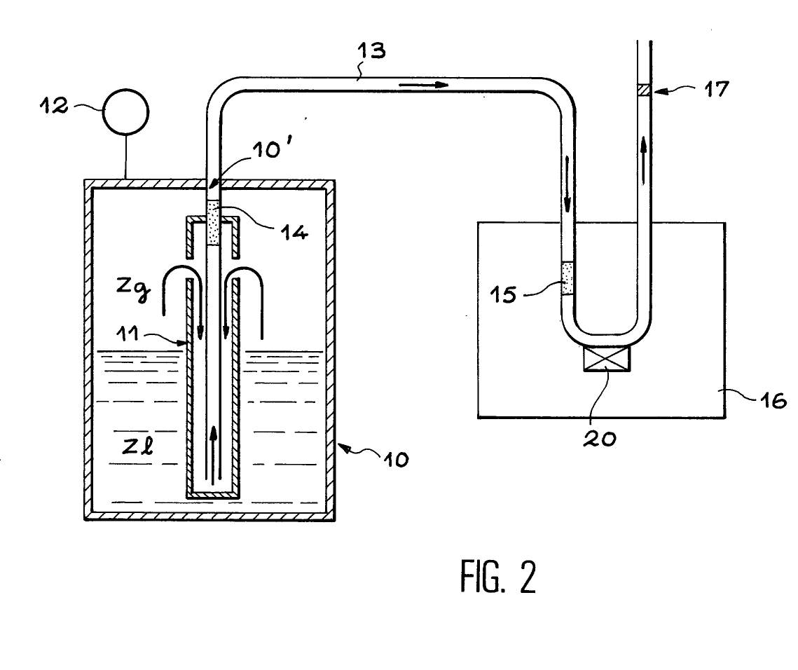

The device according to the invention is schematically represented in FIG. 2. This device includes a Dewar flask 10 pressurized by means of a pressurization device 12. This Dewar flask contains a fluid in liquid form in area Z1. The fluid used depends on the temperature to which the object is to be cooled. For a very low temperature; that is, between 5 and 30 K, the fluid may be helium.

Under the influence of the pressurization of the Dewar flask, the liquid helium is, at least partly, changed into a gas contained in the area Zg of the flask 10.

The thereby obtained gas is pre-cooled by means of a coaxial exchanger 11 immersed into the liquid helium bath.

In this FIG. 2, the path followed by the gas in the Dewar flask 10 from the zone Zg to the outlet 10′ of the Dewar flask 10 is illustrated by the arrows. At this outlet 10′, a siphon 13 provides sampling of the gas in the head space of the Dewar flask.

According to the invention, the siphon 13 is of the coaxial type, which provides collection of the gas in the Dewar. It comprises a thin wall made of stainless steel which enables promotion of thermal exchange.

At the outlet 10′ of the Dewar flask, the siphon 13 in its midst, includes a sieve 14 providing a first stabilization of the temperature of the gas. This sieve 14 is an exchanger which enables the gas to be thermally filtered.

The sieve 14 may be produced using lead or rare earth bars or beads, such as Er₃Ni, ErNi, GdRh, HoCu₂, etc. or of any other material having a very high specific heat at the temperature of the gas. The specific heat of these rare earths is published in the article entitled “A two-stage pulse tube cooler operating below 4K” by C. WANG et al. Cryogenics 1997, Vol. 37, N^{o}3, pp. 159-164. As a consequence, for a gas which temperature is comprised between 5 and 50 K, the materials used are advantageously lead or erbium 3 nickel, which have a high specific heat at these temperatures and consequently play the role of a thermal filter.

In the preferred embodiment of the invention, the sieve 14 is produced from beads made of lead or erbium 3 nickel, with a diameter of the order of 200 to 500 μm.

The siphon 13 conducts the low temperature gas, stabilized by a first sieve 14, into a cryostat 16, within which is placed an object 20 to be cooled. Preferably, the object to be cooled is placed at the outlet of the siphon 13 within the cryostat.

According to one embodiment of the invention, a second sieve 15 is placed in the siphon upstream from the object to be cooled; this second sieve 15 provides further improvement of the temperature stability of the gas.

With this second sieve 15, identical with the first sieve 14, the temperature of the gas at the inlet to the cryostat 16 may be stabilized accurately; i.e., before reaching the object to be cooled 20.

At the outlet of the cryostat 16, the siphon 13 is terminated with a variable flow port 17. This port 17 is calibrated or even set so as to enable the flow of the gas to be adjusted upon exiting the device. Stated otherwise, the temperature of the gas and so the average temperature of the object may be adjusted by means of port 17.

The coaxial siphon may, for example, have a diameter of 11 to 12 mm for the outer tube and 3 to 4 mm for the inner tube, an immersed length in the liquid of between 200 mm and 700 mm and an outlet port diameter of 3 mm.

In this example, the stainless steel tube forming the siphon contains a sieve of beads with a length of 80 mm, with a diameter of 10 mm and a mass of approximately 28.5 g.

This siphon, as with the siphons used generally in cryogenics, is protected by a vacuum guard in order to limit thermal losses.

In the preferred embodiment of the invention, the cryogenic fluid used is helium (for a temperature of 5 to 50 K). However, other gases may be used such as hydrogen or even neon (for a temperature of 50 to 60 K)

The inventive device may also be used with butane, methane, nitrogen or oxygen in applications wherein the cooling temperature must be higher than that provided in the aforedescribed embodiments; with such gases, the cooling temperatures are rather of the order of 200 to 300 K for butane and methane and of the order of 100 to 200 K for nitrogen and oxygen.

The inventive device has the benefit of being dimensioned according to the selected application. Its dimensioning is effected:

by selecting the most suitable cryogenic fluid for the target temperature;

by making measurements of thermal fluctuations at the level of the object to be cooled in the absence of a stabilization device;

by selecting the material for producing the sieve, the most suitable for the temperature to which the object is to be cooled, and

by determining the size of the sieve(s) according to the aforesaid parameters.

It shall be noted that the sieves are dimensioned by calculations that use the thermohydraulic equations describing the fluid flows and thermal exchanges; these calculations are known to one skilled in the art and given in the textbook “Initiation aux transferts thermiques” (Introduction to thermal transfers) by J. F. SACADURA of the Centre d'Actualisation Scientifique and Technique de l'INSA of Lyon, pp. 185-229.

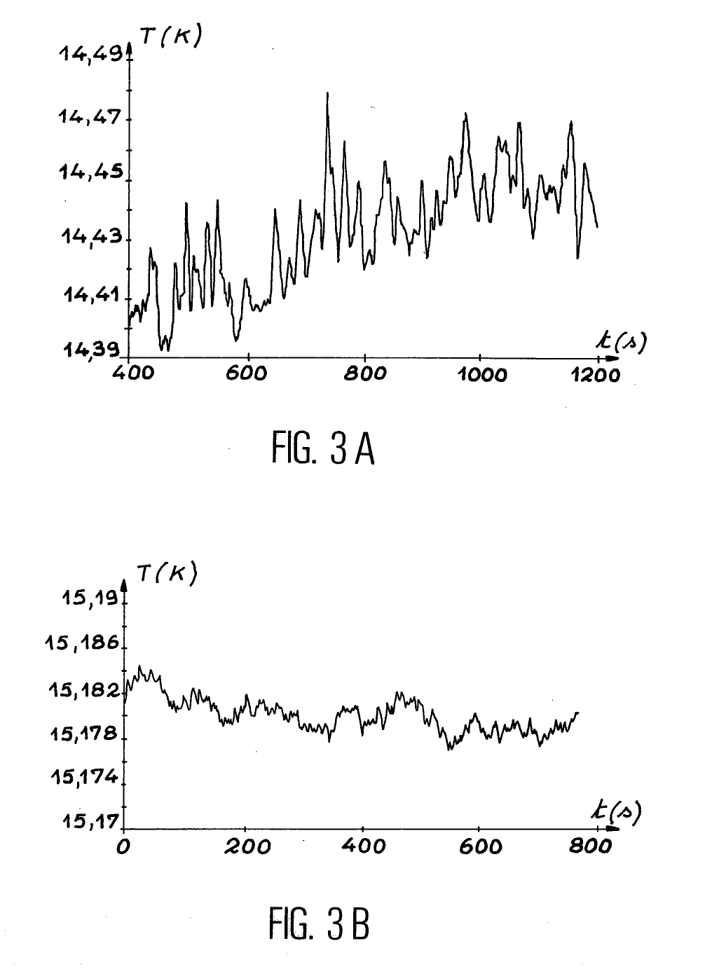

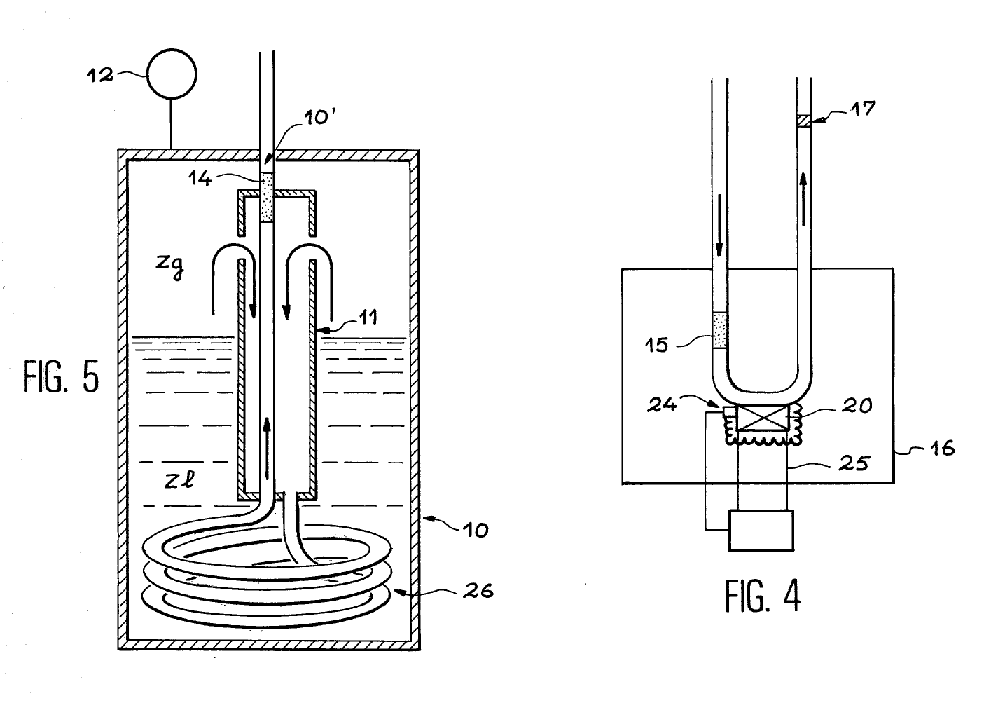

In FIGS. 3A and 3B, the curves showing the change in temperature of the object (which is a clamp in this case) in two embodiments are illustrated: for FIG. 3A the inventive device does not have a sieve at the outlet of the Dewar flask and for FIG. 3B the inventive device has a sieve 15 at the inlet to the cryostat.

Both curves were plotted under identical conditions: using the same cryogenic fluid and the same flow rate. They both show the change in temperature (in Kelvins) of the clamp versus time (in seconds).

It may be seen in FIG. 3A that the coaxial siphon 13 provided with no sieve, allows the temperature to be stabilized within 40 mK.

It may be seen in FIG. 3B that the coaxial siphon 13 provided with a sieve 15, allows the fluctuations to be limited within 4 mK.

Two additional enhancements are described below with reference to FIGS. 4 and 5.

In the embodiment of FIG. 4, at least one resistor 25 is added. Its function is to provide heat for regulating the temperature of the object 20. One does not act upon the flow of the gas but the object 20 is heated when it is too cold. The advantage is that with a stabilized gas flow, better stability of cooling is achieved in a selected temperature range.

The resistor 25 is selected according to the mass of the object 20 and to the temperature at which it is to be regulated. It shape will be adapted to the shape of the object. For example, for a round object, it may be surrounded by resistors. For an elongated object, a resistant wire will be wound around it. For a plate, a wire resistor will be used that describes several serpentines and will be placed on the surface. The power of the resistor is selected according to the enthalpy of the object. A temperature probe 24 measures the temperature of the object 20 continuously and adjusts the dissipated power in the resistor 25 by regulating its control means.

In the embodiment of FIG. 5, a coil 26 forms the siphon at the bottom of the Dewar flask 10. Its function is to reduce the gas intake temperature by better exchange with the cryogenic liquid, thus providing better utilization of the Dewar flask 10. In fact, as the whole thermal exchange occurs in the coil 26 immersed in the liquid, the thermal exchange becomes independent of the filling of the Dewar flask 10. It is better utilized. In fact, this embodiment resolves the problem that ongoing sampling of the gas which originates from vaporisation of the cryogenic liquid, reduces the level of the liquid in the Dewar flask 10 and accordingly reduces the length of thermal exchange in the exchanger 11; the more the liquid vaporizes, the hotter the gas exits.

The dimensions of the coil 26 are selected according to the minimal desired gas flow and the size of the Dewar flask 10.

The coil 26 thus extends below the bottom of the exchanger 11; the gas flows downwards in the exchanger 11, enters the siphon 13, continues to flow downward while leaving the exchanger 11, travels through the coil 26 and flows back upwards to the object 20. In such an embodiment, the exchanger 11 may cease being absolutely necessary and be eliminated.

1. A device for thermally stabilizing an object (20) to be cooled at a predetermined temperature by circulating a fluid, characterized in that it includes:
a pressure controlled Dewar flask (10) for providing a gas;
a means (11, 26) for pre-cooling the gas;
a cryostat (16) in which the object to be cooled is placed;
a siphon (13) for transferring the gas from the Dewar flask to the cryostat; the siphon including within at least one sieve (14) providing thermal filtration of the gas, and
a variable flow outlet port (17) providing discharge of the gas.

2. The device according to claim 1, characterized in that the sieve is comprised of lead or rare earth beads.

3. The device according to claim 2, characterized in that the beads have a diameter from about 200 to 500 μm.

4. The device according to any of claims 1 to 3, characterized in that it includes at least two sieves (14, 15), at least one sieve being placed within the siphon at the outlet of the exchanger and another one being placed within the siphon upstream from the object to be cooled.

5. The device according to any of claims 1 to 4, characterized in that the gas is helium for cooling to a temperature between 5 and 30 K.

6. The device according to any of claims 1 to 5, characterized in that the siphon includes a thin wall of stainless steel.

7. The device according to any of claims 1 to 5, characterized in that the siphon is coaxial.

8. The device according to any of claims 1 to 7, characterized in that an adjustable power electrical resistor is adjacent to the object (20).

9. The device according to any of claims 1 to 8, characterized in that a spiral (26) or a coil forms the siphon at the bottom of the Dewar flask (10).

10. The device according to any of claims 1 to 9, characterized in that the means for pre-cooling the gas comprises a coaxial exchanger (11).
